(19) United States
(12) Patent Application Publication
(10) Pub. No.: US 2016/0041109 A1
(43) Pub. Date: Feb. 11, 2016

(54) DETECTOR APPARATUS AND X-RAY IMAGING APPARATUS INCLUDING THE SAME

(71) Applicant: SAMSUNG ELECTRONICS CO., LTD., Suwon-si (KR)

(72) Inventors: Hyung-Jin HAM, Yongin-si (KR); Young-IK KIM, Suwon-si (KR)

(73) Assignee: SAMSUNG ELECTRONICS CO., LTD., Suwon-si (KR)

(21) Appl. No.: 14/753,719

(22) Filed: Jun. 29, 2015

(30) Foreign Application Priority Data
Aug. 11, 2014 (KR) 10-2014-0103875

(51) Int. Cl. G01N 23/04; G01T 1/20

(52) U.S. Cl. CPC G01N 23/04; G01T 1/2018

(57) ABSTRACT

An X-ray detector apparatus which includes a detector panel and a support to support the detector panel. The support is tiltably provided in a rear surface of the detector panel so that the detector panel is erected on a surface by the support.

### CROSS-REFERENCE TO RELATED APPLICATION

This application claims priority from Korean Patent Application No. 10-2014-0103875, filed on Aug. 11, 2014 in the Korean Intellectual Property Office, the disclosure of which is incorporated herein by reference in its entirety.

### BACKGROUND

1. Field

Exemplary embodiments relate to a detector apparatus capable of detecting X-rays, and an X-ray imaging apparatus including the same.

2. Description of the Related Art

X-ray imaging apparatuses may irradiate an object with X-rays, detect X-rays penetrating the object, and image an object using non-invasive methods. Medical X-ray imaging apparatuses may be used to diagnose injuries or diseases of an object, which cannot be checked through the appearance of the object.

An X-ray imaging apparatus includes an X-ray source configured to generate X-rays to irradiate an object with the x-rays, and a detector panel configured to detect the X-rays penetrating the object. The X-ray source may be movably provided to image various parts of the object.

The detector panel may be mounted at a table, or a stand. When an object to be examined with X-rays is positioned on the table, the detector panel may be mounted at the table, and when the object is examined with X-rays in a standing posture, the detector panel may be mounted at the stand.

Also, the detector panel may be used to perform X-ray examinations in a state in which the object stands on the table, depending on a position of a part of the object to be examined with X-rays, or a posture of the object. A technologist may use the detector panel to perform X-ray examinations in a state in which the object stands on the table.

### SUMMARY

One or more exemplary embodiments provide a detector apparatus capable of being erected using supports provided in the detector apparatus or being inserted into a table to examine an object with X-rays.

According to an aspect of an exemplary embodiment, a detector apparatus configured to detect X-rays generated at an X-ray generator includes a support configured to support a detector panel. Here, the support is tiltably provided at a rear surface of the detector panel and the detector panel is erected on a surface by the support.

The support may be mounted at a rear surface of the detector panel to be tiltable about a hinge.

The support may be provided to be rotatable about a straight line perpendicular to one surface of the detector panel.

A rotatably mounted rotating base may be provided in a rear surface of the detector panel, and the support may be mounted in the rotating base.

An accommodation portion in which the support is able to be accommodated may be provided in the rear surface of the detector panel.

The support may be accommodated in the accommodation portion so as not to protrude from the rear surface of the detector panel.

One surface of the support may be formed to be flush with the rear surface of the detector panel when the support is accommodated in the accommodation portion.

The support may be provided so that the length of the support is variable.

The support may include a first support mounted in the rear surface of the detector panel, and a second support mounted in the first support.

The second support may be provided to extend from the first support.

An extension may be provided at an end of the first support, and the second support may be provided to slide along the extension.

The plurality of supports may be provided.

The support may include a first support extending in one direction, and a second support extending in a direction perpendicular to the first support.

The plurality of first supports and the plurality of second supports may be provided.

A plurality of accommodation portions in which the first support and the second support are able to be accommodated, respectively, may be provided in the rear surface of the detector panel.

According to an aspect of an exemplary embodiment, an X-ray imaging apparatus includes an X-ray generator configured to generate X-rays, and a detector apparatus configured to detect the X-rays generated at the X-ray generator. Here, supports are provided in a rear surface of the detector apparatus to support the detector apparatus when one edge of the detector apparatus is placed on a surface, and when another edge adjacent to the one edge of the detector apparatus is placed on the surface.

The supports may be mounted at the rear surface of the detector apparatus to be tiltable about a hinge.

Accommodation portions in which the supports are able to be accommodated may be provided in the rear surface of the detector apparatus.

The supports may be accommodated in the accommodation portions so as not to protrude from the rear surface of the detector apparatus.

The supports may be provided so that the lengths of the supports are adjustable.

The detector apparatus may include a detector panel configured to detect X-rays, and a holder in which the detector panel is mounted.

The supports may be provided in a rear surface of the detector panel.

The supports may be provided in a rear surface of the holder.

According to an aspect of an exemplary embodiment, a detector panel configured to detect X-rays generated at an X-ray generator includes supports configured to support the detector panel to erect the detector panel. Here, the supports are provided in a rear surface of the detector panel when one of two adjacent edges of the detector panel is placed on a surface.

The support may be tiltably provided.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a diagram showing an X-ray imaging apparatus according to an exemplary embodiment;

FIG. 2 is a cross-sectional view showing a detector panel according to an exemplary embodiment;

FIG. 3 is a diagram showing the detector apparatus according to an exemplary embodiment;

FIG. 4 is a diagram showing a folded state of the support of the detector apparatus according to an exemplary embodiment;

FIG. 5 is a diagram showing the detector apparatus according to an exemplary embodiment;

FIG. 6 is a diagram showing the detector apparatus according to an exemplary embodiment, as viewed from a lateral surface thereof;

FIG. 7 is a diagram showing a detector apparatus according to an exemplary embodiment;

FIG. 8 is a diagram showing a folded state of the support of the detector apparatus according to an exemplary embodiment;

FIG. 9 is a diagram showing the detector apparatus according to an exemplary embodiment;

FIG. 10 is a diagram showing a moving unit of an X-ray imaging apparatus according to an exemplary embodiment.

### DETAILED DESCRIPTION

Reference will now be made in detail to exemplary embodiments, examples of which are illustrated in the accompanying drawings, wherein like reference numerals refer to like elements throughout. However, known functions associated with the exemplary embodiments or detailed descriptions on the configuration and other matters which would unnecessarily obscure the present disclosure will be omitted.

Hereinafter, the detector apparatus according to an exemplary embodiment, and the X-ray imaging apparatus including the same will be described in detail with reference to the accompanying drawings.

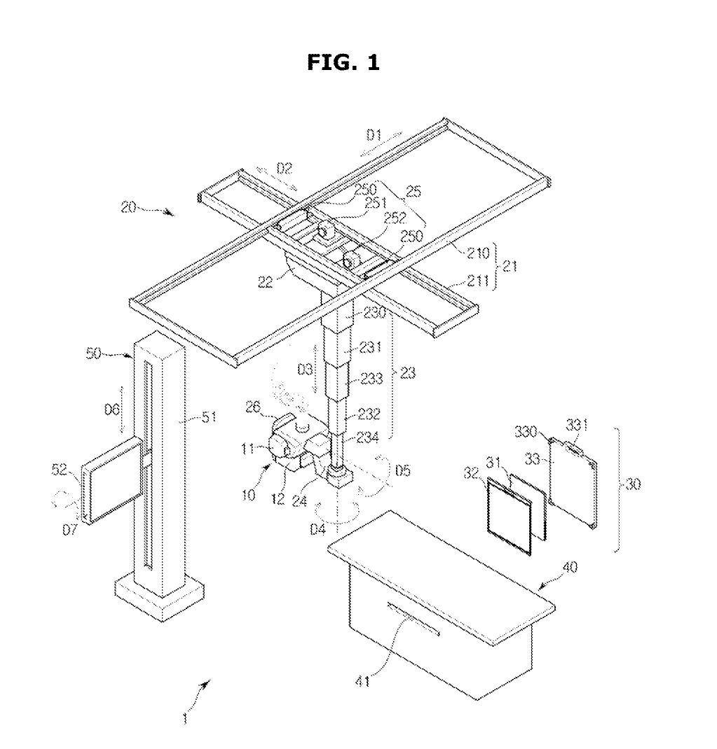

FIG. 1 is a diagram showing an X-ray imaging apparatus according to an exemplary embodiment.

Referring to FIG. 1, the X-ray imaging apparatus 1 according to an exemplary embodiment may include an X-ray generator 10, and a detector apparatus 30.

The X-ray generator 10 generates X-rays to irradiate an object with the X-rays. The X-ray generator 10 receives power from a power supply (not shown) to generate X-rays. The energy of the X-rays may be controlled by a tube voltage, and the intensity or dose of the X-rays may be controlled by a tube current and an X-ray exposure time.

The detector apparatus 30 detects X-rays penetrating an object. The detector apparatus 30 may convert the detected X-rays into electrical signals to obtain data on the X-rays.

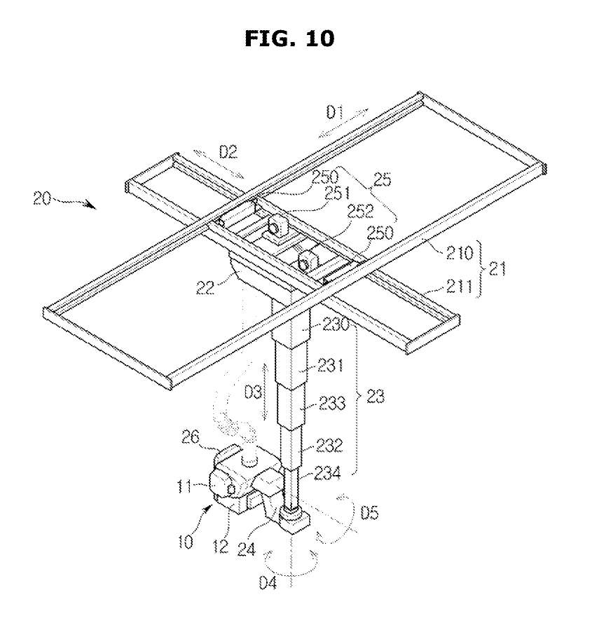

The X-ray imaging apparatus 1 may include a moving unit 20 configured to move the X-ray generator 10. The moving unit 20 may include a guide rail 21, a movable carriage 22, and a column 23, as shown in FIG. 10.

The guide rail 21 includes a first guide rail 210, and a second guide rail 211. The first guide rail 210 and the second guide rail 211 may be arranged to have a predetermined angle formed therebetween. For example, the first guide rail 210 and the second guide rail 211 may extend so that the first guide rail 210 and the second guide rail 211 are perpendicular to each other. When it is assumed that a direction in which the first guide rail 210 extends is a first direction D1, and a direction in which the second guide rail 211 extends is a second direction D2, the first direction D1 and the second direction D2 may be perpendicular to each other.

The first guide rail 210 may be installed in the ceiling of an examination room having the X-ray imaging apparatus 1 mounted therein. The second guide rail 211 may be positioned below the first guide rail 210. The second guide rail 211 may be mounted to slide along the first guide rail 210. For example, a roller provided to be movable along the first guide rail 210 may be installed at the first guide rail 210, and the second guide rail 211 may be coupled to the roller to move along the first guide rail 210.

The movable carriage 22 may be arranged under the second guide rail 211. The movable carriage 22 may be provided to be movable along the second guide rail 211. A roller movable along the second guide rail 211 may be installed at the movable carriage 22. The movable carriage 22 is movable together with the second guide rail 211 in a first direction D1, and is also movable along the second guide rail 211 in a second direction D2.

The column 23 may be positioned below the movable carriage 22. The column 23 may include a plurality of column portions 230, 231, 232, 233 and 234. The plurality of column portions 230, 231, 232, 233 and 234 may be foldably coupled to each other. The column 23 may have a length increasing or decreasing in a vertical direction of the examination room in a state in which the column 23 is fixed to the movable carriage 22. A direction in which the length of the column 23 increases or decreases may be referred to as a third direction D3. The third direction D3 may be perpendicular to the first direction D1 and the second direction D2.

The X-ray generator 10 is configured to irradiate an object with X-rays. The X-ray generator 10 may include an X-ray source 11, and a collimator 12. The X-ray source 11 generates X-rays. The collimator 12 guides the X-rays generated at the X-ray source 11 toward the object.

A rotatory joint 24 may be disposed between the X-ray generator 10 and the column 23. The rotatory joint 24 may serve to couple the X-ray generator 10 to the column 23 and bear a load applied to the X-ray generator 10.

The X-ray generator 10 may rotate about the rotatory joint 24. The X-ray generator 10 may rotate in a fourth direction D4 or a fifth direction D5 by the rotatory joint 24. The fourth direction D4 may be a direction in which the X-ray generator 10 may rotate about the axis parallel to the third direction D3. The fifth direction D5 may be a direction in which the X-ray generator 10 may rotate about the axis parallel to the first direction D1 or the second direction D2.

The X-ray generator 10 may be coupled to the rotatory joint 24 to rotate in the fourth direction D4 or the fifth direction D5. Also, the X-ray generator 10 may be coupled to the column 23 by the rotatory joint 24 to move straight in the first direction D1, the second direction D2, or the third direction D3.

A driver 25 may be provided to move the X-ray generator 10 in the first direction through the fifth directions. The driver 25 may be an electrically driven motor.

The driver 25 may be provided to correspond to the first direction D1 to the fifth direction D5. For example, the driver 25 may include a first driver 250 configured to move the second guide rail 211 in the first direction D1, and second drivers 251 and 252 configured to move the movable carriage 22 in the second direction D2. The first driver 250 may be disposed near the first guide rail 210, and the second drivers 251 and 252 may be disposed near the second guide rail 211.

The driver 25 may include a third driver (not shown) configured to increase or decrease the length of the column 23 in the third direction D3, a fourth driver (not shown) configured to rotate the X-ray generator 10 in the fourth direction D4, and a fifth driver (not shown) configured to spirally move the X-ray generator 10 in the fifth direction D5. The third driver may be disposed inside the movable carriage 22. The fourth driver and the fifth driver may be disposed near the rotatory joint 24.

A manipulator 26 configured to input a variety of types of information on X-ray examinations, and to manipulate the respective devices may be provided at one lateral surface of the X-ray generator 10.

The X-ray imaging apparatus 1 may further include a table 40 and/or a stand 50 having the detector apparatus 30 mounted therein. When an object lying on the table 40 is examined with X-rays, the detector apparatus 30 may be inserted into an accommodation portion 41 provided in the table 40. When a standing object is examined with X-rays, the detector apparatus 30 may be mounted on the stand 50.

The detector apparatus 30 may include a detector panel 31, and a grid 32. The detector panel 31 may detect X-rays penetrating the object, and convert the X-rays into electrical signals. The X-ray data on the object may be obtained by the detector panel 31.

The grid 32 may be provided in front of the detector panel 31. The grid 32 may be positioned in front of the detector panel 31 to block scattered light of the X-rays generated at the X-ray source 11. The X-ray data on the object may be obtained by blocking the scattered light of the X-rays with the grid 32.

The detector apparatus 30 may further include a holder 33. The detector panel 31, or the detector panel 31 and the grid 32 may be mounted at the holder 33. A handle 331 may be provided in the holder 33 to allow a user to easily move the detector apparatus 30.

A fixation portion 330 may be provided in the holder 33 so that the detector panel 31 or the grid 32 can be mounted on and fixed in the holder 33. The fixation portion 330 may be provided to protrude forward from an edge side of the holder 33. A portion of the fixation portion 330 interferes with the front of the detector panel 31 or the grid 32 so that the detector panel 31 or the grid 32 is not disassembled from the holder 33.

The detector apparatus 30 may be inserted into the table 40 or the stand 50 upon X-ray examinations. For this purpose, accommodation portions 41 or 52 into which the detector apparatus 30 may be inserted may be provided at the table 40 or the stand 50.

When an object to be examined with X-rays lies on the table 40, the detector apparatus 30 may be inserted into the accommodation portion 41 provided in the table 40. When a standing object is examined with X-rays, the detector apparatus 30 may be inserted into the accommodation portion 52 provided in the stand 50.

As shown in FIG. 1, the accommodation portion 52 formed in the stand 50 may be provided to be movable in a longitudinal direction of a support 51, and may be provided to rotate about the axis perpendicular to the longitudinal direction of the support 51. In this case, the longitudinal direction of the support 51 may be referred to as a sixth direction D6, and a direction in which the accommodation portion 52 rotates about the axis extending in a direction perpendicular to the longitudinal direction of the support 51 may be referred to as a seventh direction D7.

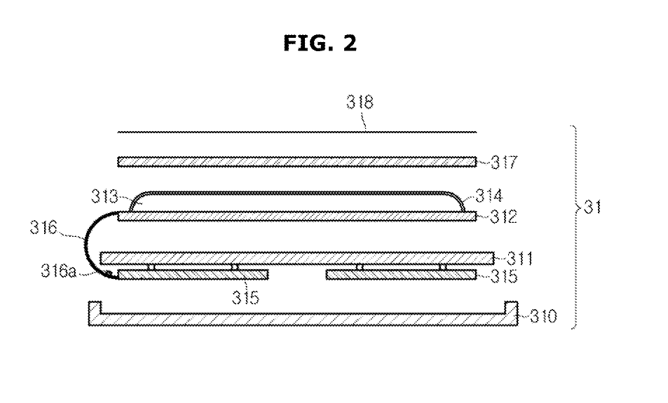

FIG. 2 is a cross-sectional view showing a detector panel according to an exemplary embodiment.

Referring to FIG. 2, the detector panel 31 according to an exemplary embodiment may include a bottom sash 310, an insulating substrate 311, a sensor panel 312, a scintillator 313, and a circuit board 315. The insulating substrate 311 may support the sensor panel 312 and the scintillator 313. The sensor panel 312 may be placed on one surface of the insulating substrate 311, and the scintillator 313 may be placed on the sensor panel 312. The circuit board 315 may be positioned on the other surface of the insulating substrate 311.

The scintillator 313 may include a fluorescent substance. The scintillator 313 may convert incident X-rays into visible rays. A cover 314 configured to protect the scintillator 313 may be positioned on one surface of the scintillator 313. The cover 314 may be formed of a metal material such as aluminum.

A top sash 317 may be positioned above the cover 314. The top sash 317 may be provided in the same shape as a carbon plate, etc. A decorative sheet 318 may be further provided at one surface of the top sash 317.

The sensor panel 312 may include a plurality of pixels, and each of the pixels may include a thin-film transistor, and a photoelectric conversion element such as a photodiode. The sensor panel 312 may determine the intensity of light, which has penetrated the scintillator 313, in units of pixels. An electric circuit configured to transfer the output by the photoelectric conversion element to the outside may be provided in the sensor panel 312.

The circuit board 315 performs an arithmetic operation to obtain images of the object using the data obtained based on signals read at the sensor panel 312. The circuit board 315 may include a memory and an arithmetic operator. The memory may store shadow information of the object according to an X-ray irradiation angle, and the arithmetic operation unit may calculate the X-ray irradiation angle based on a shadow figure of the object whose image is formed on the sensor panel 312, and shadow information of the memory. The memory and the arithmetic operation unit may also be positioned outside the detector panel 31.

The sensor panel 312 and the circuit board 315 may be coupled through a flexible printed circuit board (PCB) 316. A readout terminal 316a configured to read information of the sensor panel 312 may be positioned on the flexible PCB 316.

An accommodation portion may be formed in the bottom sash 310, and the insulating substrate 311, the sensor panel 312, the scintillator 313 and the circuit board 315 may be accommodated in the accommodation portion. Configurations of the insulating substrate 311, the sensor panel 312, the scintillator 313 and the circuit board 315 may be protected from external impacts by the bottom sash 310. The bottom sash 310 may be formed of the same material as the top sash 317.

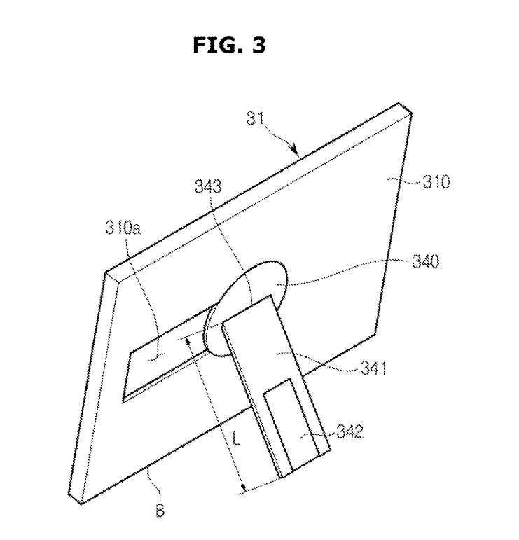

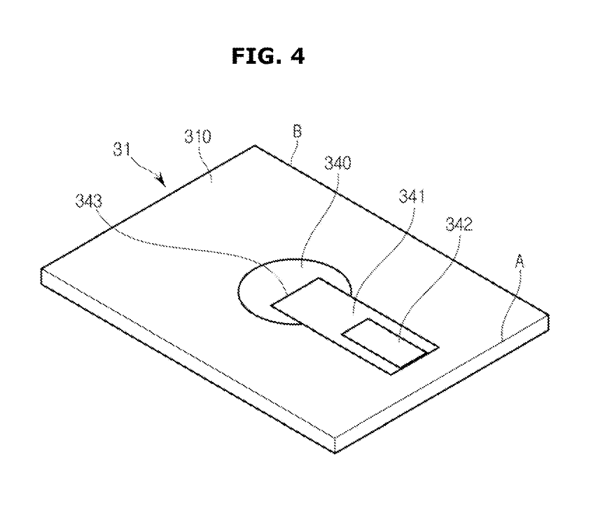

FIG. 3 is a diagram showing the detector apparatus according to an exemplary embodiment which is supported by a support, and FIG. 4 is a diagram showing a folded state of the support of the detector apparatus according to an exemplary embodiment.

Referring to FIGS. 3 and 4, supports 341 and 342 may be provided in a rear surface of the detector apparatus 30 according to an exemplary embodiment. The detector apparatus 30 may be supported by the supports 341 and 342 so that the detector apparatus 30 can be positioned on a top surface of the table 40 in a standing position.

The supports 341 and 342 may be provided in a rear surface of the holder 33, or a rear surface of the bottom sash 310 of the detector panel 31. Hereinafter, an exemplary embodiment in which the supports 341 and 342 are provided at the rear surface of the bottom sash 310 of the detector panel 31 will be described.

The supports 341 and 342 may be provided to be tiltable about a hinge 343. When the detector panel 31 is inserted into the accommodation portion 41 formed in the table 40, or the accommodation portion 52 formed in the stand 50, surfaces of the supports 341 and 342 may be folded so that the surfaces of the supports 341 and 342 come in contact with the rear surface of the bottom sash 310. The detector panel 31 may be supported and erected by the supports 341 and 342 according to a position of the object to be examined with X-rays.

A fixing structure capable of maintaining a tilted angle when the supports 341 and 342 are tilted to form a predetermined angle with the rear surface of the bottom sash 310 and thus support the detector panel 31 may be provided in one side of the hinge 343. The fixing structure may include an elastic member, etc. A configuration of the fixing structure may be applied to conventional configurations.

A user may insert the detector panel 31 into the accommodation portion 41 formed in the table 40 when the object is examined with X-rays in a state in which the object lies on table 40, depending on a position of the object to be examined with X-rays. When the object is examined with X-rays in a standing posture, the detector panel 31 may be inserted into the accommodation portion 52 formed in the stand 50.

When the detector panel 31 is not easily positioned on the accommodation portion 41 or 52 provided in the table 40 or the stand 50 to examine the object with X-rays according to a position and a posture of the object to be examined with X-rays, the object may be examined with X-rays in a state in which the detector panel 31 stands on the table 40, or the other tables. The object to be examined with X-rays may be positioned in front of the detector panel 31 standing on the table 40 or the like, and may be examined with X-rays.

In the case of the related art, when an object to be examined with X-rays does not easily take a proper posture for X-ray examinations, the X-ray examinations are performed by a technologist in a state in which the detector panel 31 is arranged in a proper position for X-ray examinations. In this case, additional personnel are needed upon X-ray examinations, and the technologist may be exposed to radiation.

The detector panel may be erected by a holding mechanism provided separately from the X-ray imaging apparatus, the table, the stand, or the like. In this case, a space for a separate holding mechanism is required, which results in limitations on use of the space, and a lot of time taken for a technologist to detach the detector panel from the holding mechanism may be required.

According to an exemplary embodiment, the supports 341 and 342 provided to be tiltable by the hinge 343 may be provided at the rear surface of the detector panel 31 so that the supports 341 and 342 can be optionally tilted to enable the detector panel 31 to be supported by the supports 341 and 342.

As described above, when the detector panel 31 is supported by the supports 341 and 342 provided to be tiltable, the detector panel 31 may be erected at a desired position to examine an object with X-rays without any help from a technologist, thereby preventing the technologist from being exposed to radiation. Also, since no separate holding mechanisms are required, limitations on use of the space may be prevented, a time needed to attach and detach the detector panel 31 may be saved.

An accommodation portion 310a into which the supports 341 and 342 may be inserted when the detector panel 31 is not supported by the supports 341 and 342 may be formed in a rear surface of the bottom sash 310. When the supports 341 and 342 are inserted into the accommodation portion 310a, the surfaces of the supports 341 and 342 may form the same flat surface with the rear surface of the bottom sash 310, or the surfaces of the supports 341 and 342 may be formed at a lower position than that of the rear surface of the bottom sash 310 so that the supports 341 and 342 do not protrude from the rear surface of the bottom sash 310.

When the supports 341 and 342 are inserted into the accommodation portion 310a, an elastic member providing an elastic force to the supports 341 and 342, or the like may be provided at a side of the hinge 343 so that the supports 341 and 342 are not extracted from the accommodation portion 310a without any external force. The supports 341 and 342 may be tilted about the hinge 343 due to the external force to support the detector panel 31.

The supports 341 and 342 may include a first support 341 coupled to the rear surface of the bottom sash 310 by the hinge 343, and a second support 342 slidingly mounted in the first support 341. The first support 341 may be mounted in the bottom sash 310 to be rotatable about a rotation axis, which extends in a direction perpendicular to one surface of the bottom sash 310, via a rotating base 340. The content regarding this configuration will be described below.

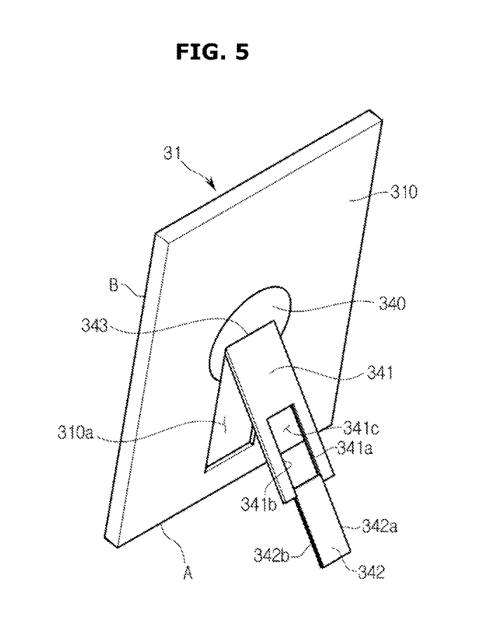

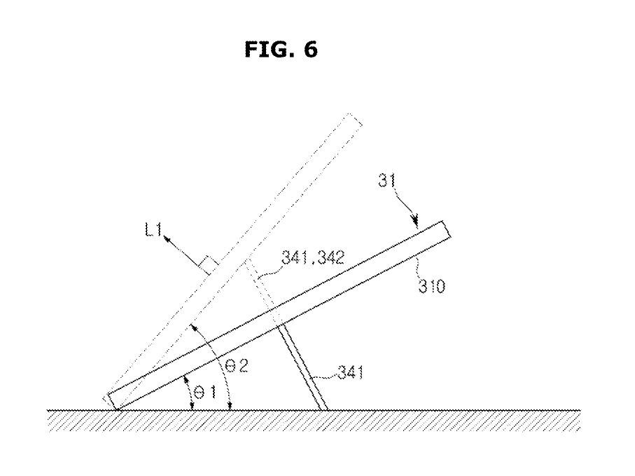

FIG. 5 is a diagram showing the detector apparatus according to an exemplary embodiment which is supported by the support, and FIG. 6 is a diagram showing the detector apparatus according to an exemplary embodiment, as viewed from a lateral surface thereof.

Referring to FIGS. 3, 5 and 6, the detector apparatus 30 according to an exemplary embodiment may be provided in a rectangular shape having different widths and height lengths. That is, the detector panel 31 may be provided in a rectangular shape having different lengths at adjacent edges thereof. Hereinafter, an edge having a shorter length may be referred to as a longitudinal edge A, and an edge having a longer length may be referred to as a horizontal edge B.

The accommodation portion 310a may be formed to correspond to the shapes of the supports 341 and 342. For example, the accommodation portion 310a may be formed to extend parallel to the horizontal edge or the longitudinal edge. Hereinafter, an exemplary embodiment in which the accommodation portion 310a extends parallel to the longitudinal edge will be described.

When the horizontal edge of the detector panel 31 is placed on a surface (e.g., a floor, a table, a horizontal surface), a user tilts the supports 341 and 342 about the hinge 343 by applying an external force to the supports 341 and 342 inserted into the accommodation portion 310a. The tilted supports 341 and 342 may support the rear surface of the detector panel 31 to erect the detector panel 31 on the surface, as shown in FIG. 5.

The supports 341 and 342 may be provided so that supports are slidingly provided in an extension direction of the supports to vary the entire length of the supports. The lengths of the supports 341 and 342 may be varied to adjust an angle formed between the detector panel 31 and a surface.

For example, the supports 341 and 342 may include a first support 341, and a second support 342. The first support 341 may be tiltably mounted in the rear surface of the bottom sash 310 by the hinge 343. The second support 342 may be slidingly mounted in one side of the first support 341. The second support 342 may slide in an extension direction of the first support 341.

Extensions 341a and 341b may be provided at the first support 341. One end of the first support 341 may be coupled to the bottom sash 310 by the hinge 343, and the extensions 341a and 341b further extending in the extension direction of the first support 341 may be provided at the other end of the first support 341.

The extensions 341a and 341b may include a first extension 341a and a second extension 341b, which are spaced apart from each other to extend parallel to each other. An insertion portion 341c in which the second support is slidingly inserted may be formed between the first extension 341a and the second extension 341b.

Rail units 344a and 344b may be provided to guide movement of the second support 342 may be provided at an inner lateral surface of the first extension 341a and an inner lateral surface of the second extension 341b. The rail units 344a and 344b may be rail grooves formed respectively in the inner lateral surface of the first extension 341a and the inner lateral surface of the second extension 341b. The rail grooves formed respectively in the inner lateral surface of the first extension 341a and the inner lateral surface of the second extension 341b may extend in a longitudinal direction of the first extension 341a and the second extension 341b.

Protrusions 342a and 342b into which the rail units 344a and 344b formed in the first extension 341a and the second extension 341b may be inserted may be formed in an outer lateral surface of the second support 342. The protrusions 342a and 342b may be inserted into the rail units 344a and 344b to slide.

Although an exemplary embodiment in which the rail grooves are formed in the extensions 341a and 341b and the protrusions 342a and 342b are formed in the outer lateral surface of the second support 342 has been described in the foregoing, positions and shapes of the rail units, and positions and configurations of parts sliding along the rail units are not limited to the contents as described above.

A user may vary the lengths of the supports 341 and 342 by sliding the second support 342. The angle formed between the detector panel 31 and a surface may vary by changing the entire length of the supports 341 and 342. For example, when it is assumed that an angle formed between a surface and the detector panel 31 is ‘θ1’ when the second support 342 is inserted into the insertion portion 341c, and an angle between the detector panel 31 and the surface is ‘θ2’ when the second support 342 is extracted from the insertion portion 341c, and the length L of the supports 341 and 342 gets longer than before, θ2 may be longer than θ1.

The supports 341 and 342 may be rotatably mounted in the rear surface of the detector panel 31 via the rotating base 340. The rotating base 340 may be rotatably provided clockwise or counterclockwise in a range of 90°.

The rotating base 340 may be mounted on the rear surface of the detector panel 31 so that the rotating base 340 can rotate using a straight line L1 perpendicular to one surface of the detector panel 31 as the rotation axis, and the supports 341 and 342 may be mounted on the rotating base 340. Accordingly, the supports 341 and 342 may be mounted in the rear surface of the detector panel 31 to be rotatable about the straight line L1 perpendicular to one surface of the detector panel 31. The rotating base 340 may be provided at the center of the detector panel 31.

Specifically, one lateral end of the first support 341 may be mounted in the rotating base 340 to be tiltable about the hinge 343, and the second support 342 may be mounted in the other lateral end of the first support 341 so that the second support 342 can slide to extend in length.

When the detector panel 31 is erected to place the edge A having a shorter length on a surface, a user may tilt the first support 341 about the hinge 343 so that the detector panel 31 is supported by the support 341. The second support 342 may be slid to protrude from the first support 341, or may be inserted into the insertion portion 341c of the first support 341 to adjust an angle formed between the surface and the detector panel 31.

When a user wants to erect the detector panel 31 to place the edge B having a longer length on a surface, the user may apply an external force to extract the supports 341 and 342 from the accommodation portion 310a, and then rotate the supports 341 and 342 clockwise or counterclockwise so that the supports 341 and 342 support the detector panel 31. Since the rotating base 340 is rotatably provided on the rear surface of the bottom sash 310, the supports 341 and 342 coupled to the rotating base 340 may rotate together with the rotating base 340 about the straight line L1 perpendicular to one surface of the detector panel 31.

As described above, since the supports 341 and 342 are rotatably provided, a user may position the detector panel 31 to extend in a longitudinal direction, which is a direction facing upward from the surface, by settling the edge A of the detector panel 31 having a shorter length on the surface, or may position the detector panel 31 to extend in a horizontal direction by settling the edge A of the detector panel 31 having a longer length on the surface for the sake of convenience.

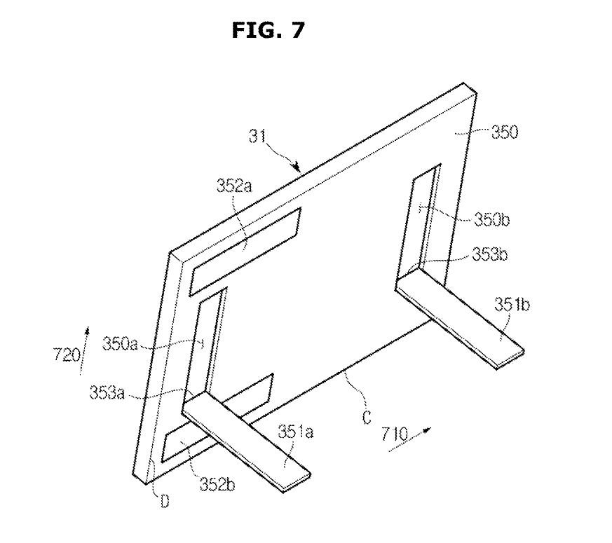

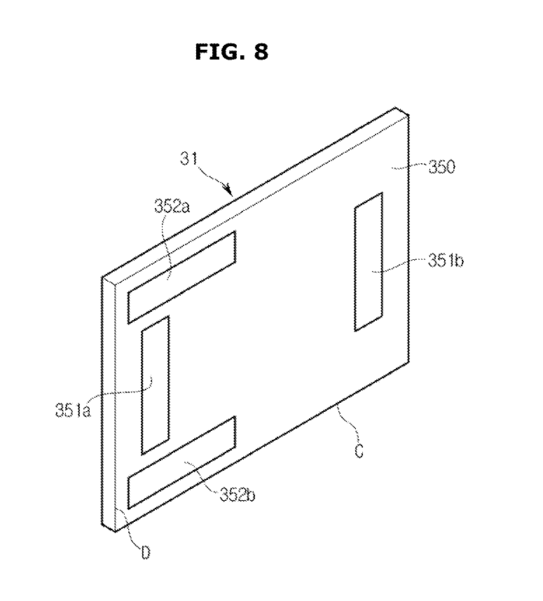

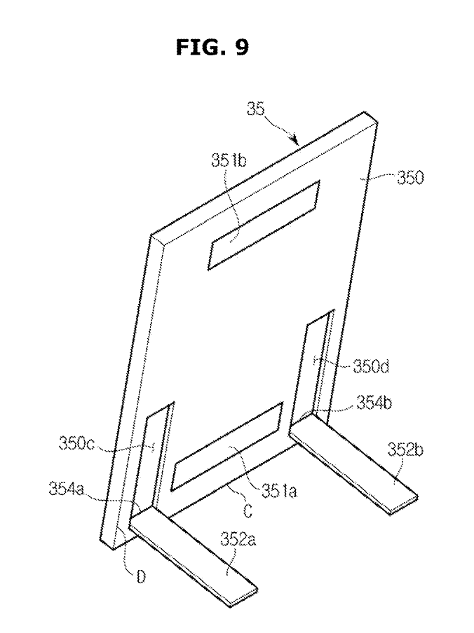

FIG. 7 is a diagram showing a detector apparatus according to an exemplary embodiment which is supported by a support, FIG. 8 is a diagram showing a folded state of the support of the detector apparatus according to an exemplary embodiment, and FIG. 9 is a diagram showing the detector apparatus according to an exemplary embodiment which is supported by the support.

Referring to FIGS. 7 to 9, a plurality of supports 351a, 351b , 352a and 352b may be provided at a rear surface of the detector panel 31 according to an exemplary embodiment. The plurality of supports 351a, 351b , 352a and 352b may include first supports 351a and 351b arranged along a first direction 710, and second supports 352a and 352b arranged along a second direction 720.

Here, the first direction refers to a direction in which an edge C of the detector panel 31 extends, and the second direction refers to a direction in which another edge D adjacent to the edge C of the detector panel 31 extends. When the detector panel 31 is provided in a rectangular shape, the second direction is perpendicular to the first direction. Therefore, the first supports 351a and 351b may extend in a direction perpendicular to the first supports 352a and 352b.

The plurality of first supports 351a and 351b and the plurality of second supports 352a and 352b may be provided. An exemplary embodiment in which two first supports 351a and 351b and two second supports 352a and 352b are provided is shown in FIGS. 6 to 9.

The first supports 351a and 351b may be provided in a rear surface of the detector panel 31 so that two first supports 351a and 351b are spaced apart from each other to extend in a first direction. The first supports 351a and 351b may support the rear surface of the detector panel 31 so that the detector panel 31 can be erected at a predetermined angle formed between the detector panel 31 and a surface when the edges C extending in the first direction of the detector panel 31 are placed on the surface.

The first supports 351a and 351b may be mounted in the rear surface of the detector panel 31 to be tiltable about hinges 353a and 353b. Accommodation portions 350a and 350b into which the first supports 351a and 351b may be inserted may be formed in the rear surface of the detector panel 31. When the detector panel 31 is mounted in the accommodation portion 41 or 52 provided at the stand 50 or the table 40 to perform X-ray examinations, the first supports 351a and 351b may be accommodated in the accommodation portions 350a and 350b.

When the first supports 351a and 351b are accommodated in the accommodation portions 350a and 350b, surfaces of the first supports 351a and 351b may be formed to be flush with the rear surface of the detector panel 31, or may be provided to be positioned at a lower position than the height of the rear surface of the detector panel 31 that the first supports 351a and 351b do not protrude from the rear surface of the detector panel 31. Accordingly, when the detector panel 31 is inserted into the accommodation portions 41 or 52 formed in the table 40 or the stand 50, the first supports 351a and 351b may not interfere with the detector panel 31.

When the detector panel 31 is supported by the first supports 351a and 351b, the second supports 352a and 352b may also be accommodated in accommodation portions 350c and 350d formed in the rear surface of the detector panel 31.

The second supports 352a and 352b may be provided to extend in a direction perpendicular to the first supports 351a and 351b . For example, the second supports 352a and 352b may be provided in the rear surface of the detector panel 31 so that the two second supports 352a and 352b are spaced apart from each other to extend in a second direction. The second supports 352a and 352b may support the rear surface of the detector panel 31 so that the detector panel 31 can be erected at a predetermined angle formed between the detector panel 31 and the surface when the edges D extending in the second direction of the detector panel 31 are placed on the surface.

The second supports 352a and 352b may be mounted in the rear surface of the detector panel 31 to be tiltable about hinges 354a and 354b. The accommodation portions 350c and 350d into which the second supports 352a and 352b may be inserted may be formed in the rear surface of the detector panel 31, and thus the second supports 352a and 352b may be accommodated in the accommodation portions 350c and 350d when the detector panel 31 is supported by the second supports 352a and 352b.

When the second supports 352a and 352b are accommodated in the accommodation portions 350c and 350d, the surfaces of the second supports 352a and 352b may be formed to be flush with the rear surface of the detector panel 31, or may be provided to be positioned at a lower position than the height of the rear surface of the detector panel 31 that the second supports 352a and 352b do not protrude from the rear surface of the detector panel 31. Accordingly, when the detector panel 31 is inserted into the accommodation portion 41 or 52 formed in the table 40 or the stand 50, the second supports 352a and 352b may not interfere with the detector panel 31.

When the detector panel 31 is supported by the second supports 352a and 352b, the first supports 351a and 351b may also be accommodated in the accommodation portions 350a and 350b.

The first supports 351a and 351b and the second supports 352a and 352b may have different lengths according to the shape of the detector panel 31. The amount of the first supports 351a and 351b and the second supports 352a and 352b provided are not limited to the values as described above.

Also, each of the first supports 351a and 351b and second supports 352a and 352b according to an exemplary embodiment may be provided so that the entire length of each of the first supports 351a and 351b and second supports 352a and 352b is variable, as described in the supports 341 and 342 according to an exemplary embodiment.

The first supports 351a and 351b and the second supports 352a and 352b may also be provided at a bottom sash 350 of the detector panel 31, and may also be provided at a rear surface of a holder in which the detector panel 31 is mounted.

As described above, the supports configured to support the detector panel may be formed integrally with the detector panel or the holder having the detector panel mounted therein to prevent a technologist from being exposed to radiation, lift limitations on space caused due to the presence of a separate holding mechanism, and easily erect the detector panel on a surface. Since the supports are provided so that the supports do not protrude from a rear surface of the detector panel, or a rear surface of the holder, the supports may not interfere with inserting the detector panel into the accommodation portion formed in the stand or the table.

According to an exemplary embodiment, since the detector apparatus may be erected using the supports provided in the detector apparatus, the detector apparatus may be readily positioned at a position in which X-rays are easily detected, depending on a posture of an object, or a position of a diseased part of the object to be imaged with X-rays. Also, the detector apparatus may be erected without any help from a technologist, thereby preventing the technologist from being exposed to radiation.

Although exemplary embodiments have been shown and described, it would be appreciated by those skilled in the art that changes may be made in these exemplary embodiments without departing from the principles and spirit of the exemplary embodiments, the scope of which is defined in the claims and their equivalents.

What is claimed is:

1. An X-ray detector apparatus comprising:
a detector panel; and
a support which is configured to support the detector panel and is tiltably provided at a rear surface of the detector panel, wherein the detector panel is configured to be erected on a surface by the support.

2. The X-ray detector apparatus of claim 1, wherein the support is mounted at the rear surface of the detector panel to be tiltable about a hinge.

3. The X-ray detector apparatus of claim 1, wherein the support is provided to be rotatable about a straight line perpendicular to a surface of the detector panel.

4. The X-ray detector apparatus of claim 3, further comprising a rotatably mounted rotating base provided at the rear surface of the detector panel,
wherein the support is mounted in the rotating base.

5. The X-ray detector apparatus of claim 1, further comprising an accommodation portion which is configured to accommodate the support and provided at the rear surface of the detector panel.

6. The X-ray detector apparatus of claim 5, wherein the support is accommodated in the accommodation portion so as not to protrude from the rear surface of the detector panel.

7. The X-ray detector apparatus of claim 5, wherein a surface of the support is formed to be flush with the rear surface of the detector panel when the support is accommodated in the accommodation portion.

8. The X-ray detector apparatus of claim 1, wherein a length of the support is variable.

9. The X-ray detector apparatus of claim 8, wherein the support comprises a first support mounted at the rear surface of the detector panel, and a second support mounted in the first support.

10. The X-ray detector apparatus of claim 9, wherein the second support is configured to extend from the first support.

11. The X-ray detector apparatus of claim 9, wherein an extension is provided at an end of the first support, and the second support is provided to slide along the extension.

12. The X-ray detector apparatus of claim 1, wherein the support is one of a plurality of supports which are provided to support the detector panel.

13. The X-ray detector apparatus of claim 12, wherein each of the plurality of supports comprises a first support extending in a first direction, and a second support extending in a second direction perpendicular to the first support.

14. The X-ray detector apparatus of claim 13, further comprising a plurality of accommodation portions provided at the rear surface of the detector panel,
wherein each of the plurality of accommodation portions is configured to accommodate the first support and the second support.

15. An X-ray imaging apparatus comprising:
an X-ray generator configured to generate X-rays; and
a detector apparatus configured to detect the generated X-rays,
wherein supports are provided at a rear surface of the detector apparatus to support the detector apparatus at an angle to a surface when a first edge of the detector apparatus is placed on the surface or when a second edge adjacent to the first edge is placed on the surface.

16. The X-ray imaging apparatus of claim 15, wherein the supports are mounted at the rear surface of the detector apparatus to be tiltable about a hinge.

17. The X-ray imaging apparatus of claim 15, wherein accommodation portions are provided at the rear surface of the detector apparatus and the supports are configured to be accommodated in the accommodation portions.

18. The X-ray imaging apparatus of claim 17, wherein the supports are accommodated in the accommodation portions so as not to protrude from the rear surface of the detector apparatus.

19. The X-ray imaging apparatus of claim 15, wherein a length of the supports is adjustable.

20. The X-ray imaging apparatus of claim 15, wherein the detector apparatus comprises a detector panel configured to detect X-rays, and a holder in which the detector panel is mounted.

21. The X-ray imaging apparatus of claim 20, wherein the supports are provided in a rear surface of the detector panel.

22. The X-ray imaging apparatus of claim 20, wherein the supports are provided in a rear surface of the holder.

23. An X-ray detector apparatus comprising:
supports which are provided at a rear surface of the X-ray detector apparatus and configured to support the X-ray detector apparatus when one of two adjacent edges of the X-ray detector apparatus is placed on a surface.

24. The X-ray detector apparatus of claim 23, wherein the supports are tiltably provided.

25. An X-ray detector apparatus comprising:
a support hingedly connected to a first side of the X-ray detector apparatus to support the X-ray detector apparatus in an erected position on a surface; and
an accommodation portion configured to receive the support when the X-ray apparatus is not supported by the support,
wherein an entirety of the support is flush with the first side of the X-ray detector apparatus when the support is received in the accommodation portion.

26. The X-ray detector apparatus of claim 25, further comprising:
a rotating base disposed on the first side of the X-ray detector apparatus,
wherein the support is hingedly connected to the rotating base.

27. The X-ray detector apparatus of claim 25, wherein the support further comprises:
a first support configured to tilt in a first direction; and
a second support configured to tilt in a second direction,
wherein the first direction is perpendicular to the second direction.
